(19) United States
(12) Patent Application Publication
(10) Pub. No.: US 2026/0161818 A1
(43) Pub. Date: Jun. 11, 2026

(54) PRIVACY REGULATORY SYSTEM

(71) Applicant: Zahra ZANDESH, Tehran (IR)

(72) Inventor: Zahra ZANDESH, Tehran (IR)

(21) Appl. No.: 18/709,829

(22) PCT Filed: Oct. 2, 2022
(86) PCT No.: PCT/IB2022/059385

§ 371 Date: May 14, 2024

(51) Int. Cl. G06F 21/62; G06F 21/32

(52) U.S. Cl. CPC G06F 21/6245; G06F 21/32; G06F 2221/2141

(57) ABSTRACT

A privacy regulatory system comprising a user device, a service provider device, an authentication server, and a privacy operation center system. The user device may be connected to the privacy regulatory system through an internet network of the user device to receive user data from a user. The service provider device may be connected to the privacy regulatory system through an internet network of the service provider device. The privacy operation center system may comprise a user portal, a service provider portal, a database in a third-party side, a permission engine, and a query management unit. The database in the third-party side may comprise a log database, an encrypted permission repository, and an encrypted data database. The user portal may comprise a user profile module and a user privacy dashboard. The service provider portal may comprise a service provider profile module and a service provider privacy dashboard.

### CROSS-REFERENCE TO RELATED APPLICATION

This application claims the benefit of priority from U.S. Provisional Patent Application Ser. No. 63/283,551, filed on Nov. 29, 2021, and entitled “Privacy Monitoring Method and System in Cloud Environment” which is incorporated herein by reference in its entirety.

### TECHNICAL FIELD

The present disclosure generally relates to an exemplary regulatory technology, and more particularly to an exemplary data monitoring and management system with an exemplary high privacy protection method.

### BACKGROUND

A regulatory system provides a platform for a user to get various services through an internet network. In a regulatory system, cooperation between different resources and service providers is occurred to deliver a service to a user based on the user data. On the other hand, the users concern about their privacy in the regulatory system. Therefore, it is necessary to protect the user data in the regulatory system. Providing a safe method for controlling privacy and security in the regulatory system, is one of the most challenging task in the regulatory technology especially for cloud applications.

While there are various methods to improve privacy in cloud or non-cloud environment, they are mostly limited to cryptography or authentication methods. However, privacy does not limit to cryptography or authentication. On the other hand, privacy has different aspects which should be maintained from data acquisition time to deliver a service to the user. Furthermore, even after delivering a service to the user, the user data may be stored in a database in a third-party side and the privacy concern may be still necessary. Moreover, each person may have different priorities and demands. Thereby, there is a need to develop a personalized comprehensive system for regulatory technology that may consider all privacy aspects according to the priorities and demands of each user in which the user may enable to monitor what happens to the data before, during, and after getting service. This regulatory system is flexible to deploy data equalization unit management, data management, compliance management and prosses management in different business in order to provide personalized privacy according to international disciplines and individuals priorities.

### SUMMARY

This summary is intended to provide an overview of the subject matter of one or more exemplary embodiments, and is not intended to identify essential elements or key elements of the subject matter, nor is it intended to be used to determine the scope of the claimed implementations. Its sole purpose is to present some concepts of one or more aspects in a simplified form as a prelude to the more detailed description that is presented later. The proper scope of one or more exemplary embodiments may be ascertained from the claims set forth below in view of the detailed description below and the drawings.

In one general aspect, the present disclosure may describe a privacy regulatory system. In one or more exemplary embodiments, the privacy regulatory system may comprise a user device, a service provider device, an authentication server, and a privacy operation center system. The user device may be connected to the privacy regulatory system through an internet network of the user device to receive user data from a user. The service provider device may be connected to the privacy regulatory system through an internet network of the service provider device. The authentication server may verify user identity information and service provider identity information.

In an exemplary embodiment, the privacy operation center system may comprise a user portal, a service provider portal, a database in a third-party side, a permission engine, and a query management unit. In one or more exemplary embodiments, the permission engine may search a plurality of permissions. The query management unit may receive user query and service provider query.

In one exemplary embodiment, the database in the third-party side may comprise a log database, an encrypted permission repository, and an encrypted data repository. In one or more exemplary embodiments, the log database may store a plurality of events. The encrypted permission repository may store a plurality of permissions given by the user. Each respective permission of the plurality of permissions determines whether a predetermined user data is accessible to a service provider. In an exemplary embodiment, the encrypted data repository may receive, send, and share a plurality of encrypted user data. The plurality of encrypted user data is sent by the user device or the service provider device through the internet network of the user device or the internet network of service provider device, respectively.

In one exemplary embodiment, the user portal may comprise a user profile module and a user privacy dashboard. The user profile module may comprise user information and the user data. The user privacy dashboard may protect the user data. In one exemplary embodiment, the user profile module and the user privacy dashboard may be created in the user portal when the user may register in the privacy regulatory system through a user registration procedure.

In one exemplary embodiment, the service provider portal may provide an environment for a service provider to access the user data. The service provider portal may comprise a service provider profile module and a service provider privacy dashboard. The service provider profile module may comprise service provider information. The service provider privacy dashboard may protect the service provider information and the user data. In an exemplary embodiment, the service provider profile module and the service provider privacy dashboard may be created in the service provider portal when the service provider may register in the privacy regulatory system through a service provider registration procedure.

This Summary may introduce a number of concepts in a simplified format; the concepts are further disclosed within the “Detailed Description” section. This Summary is not intended to configure essential/key features of the claimed subject matter, nor is intended to limit the scope of the claimed subject matter.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for the purpose of illustration and description only and are not intended as a definition of the limits of the present disclosure. Embodiments of the present disclosure will now be described by way of example in association with the accompanying drawings in which:

FIG. 1 illustrates a structural architecture of an exemplary privacy regulatory system for privacy monitoring of a cloud application with focus on healthcare industry requirements, consistent with one or more embodiments of the present disclosure;

FIG. 2 illustrates a schematic representation of an exemplary privacy operation center system for privacy monitoring of a cloud application with focus on healthcare industry requirements, consistent with one or more embodiments of the present disclosure;

FIG. 3 illustrates a schematic representation of an exemplary relationship between different players in a privacy regulatory system for privacy monitoring of a cloud application to access the user data, consistent with one or more embodiments of the present disclosure;

FIG. 4 illustrates a flowchart of user registration procedure implemented in an exemplary privacy regulatory system, consistent with one or more embodiments of the present disclosure;

FIG. 5 illustrates a flowchart of service provider registration procedure implemented in an exemplary privacy regulatory system, consistent with one or more exemplary embodiments of the present disclosure;

FIG. 6 illustrates a flowchart of data storage procedure in an exemplary privacy regulatory system, consistent with one or more exemplary embodiments of the present disclosure;

FIG. 7 illustrates a flowchart of log monitoring procedure in an exemplary privacy regulatory system, consistent with one or more exemplary embodiments of the present disclosure;

FIG. 8 illustrates a flowchart of service provider data management procedure in an exemplary privacy regulatory system, consistent with one or more exemplary embodiments of the present disclosure;

FIG. 9 illustrates a flowchart of data referring procedure in an exemplary privacy regulatory, consistent with one or more exemplary embodiments of the present disclosure; and

FIG. 10 illustrates a flowchart of second user data observation procedure in an exemplary privacy regulatory system, consistent with one or more exemplary embodiments of the present disclosure.

### DETAILED DESCRIPTION

In the following detail description, various embodiments of the present disclosure are explained to enable an expert person in the art to make or use the method or system disclosed in the present disclosure. However, the specific details of the present disclosure may be achieved without the disclosed exemplary embodiment which may be obvious for an expert person in the art.

In the following detailed description, numerous specific details are set forth by way of examples to provide a thorough understanding of the relevant teachings related to the exemplary embodiments. However, it should be apparent that the present teachings may be practiced without such details. In other instances, well-known methods, procedures, components, and/or circuitry have been described at a relatively high level, without detail, in order to avoid unnecessarily obscuring aspects of the present teachings.

The technical problem solved by the present disclosure is to provide a high privacy monitoring system especially for a cloud application in which the user that is the owner of the shared data may enable to monitor any change that may be happened to the user data. Furthermore, any observation, usage, and decision about the user data may be made under the user permission and the user consent. All activities are user centered according to whole data life cycle. Disclosed herein may have various application like agriculture, real estate, citizen services, marketing, education, and healthcare in cloud or non-cloud environment.

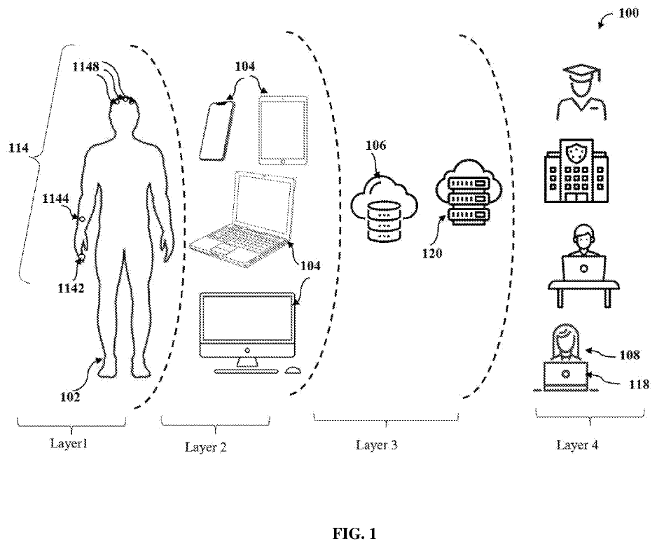

Referring now to the figures, FIG. 1 illustrates a structural architecture of a privacy regulatory system 100 for privacy monitoring of a cloud application with focus on healthcare industry requirements, consistent with one or more embodiments of the present disclosure. In privacy regulatory system 100 the user may be a patient 102 and the service provider may be a physician 108. Privacy regulatory system 100 may be designed with four layers including layers 1-4. In an exemplary embodiment, layer 1 and layer 2 may be related to the user side, layer 3 may be related to a third-party side, and layer 4 may be related to the service provider side. The third-party side is an entity that provide an environment for interaction of the user and the service provider, which may include cloud or non-cloud environment. The third-party for the cloud application may be a cloud provider. Each layer may be connected to the next layer through an internet network which may be a wired or wireless network. In one exemplary embodiment, referring to privacy regulatory system 100, patient 102 may use privacy regulatory system 100 to get a medical service from physician 108; in which Privacy Operation Center system (POCs) 106 may guarantee the privacy of the patient data. In an exemplary embodiment, authentication server 120 may verify and authenticate the identity information of patient 102, physician 108, or any other person who may use privacy regulatory system 100. In an exemplary embodiment, the identity information may include, but is not limited to, a personal identification number, an Internet Protocol (IP) address, an email address, a social security number passport number, a patient identification number, a financial account number, a credit card number, a personal address information, a personal telephone numbers, or any similar information.

In one exemplary embodiment, patient 102 may enter the patient data manually through patient device 104. Patient device 104 may be connected to POCs 106 in privacy regulatory system 100 through an internet network of the patient device. In one or more exemplary embodiments, patient device 104 may include, but is not limited to, smartphone, tablet, laptop, and personal computer. In an exemplary embodiment, the patient device 104 may receive an exemplary of the patient data automatically through a data acquisition unit 114. Data acquisition unit 114 may record a plurality of physiological parameters automatically through pulse oximeter device 1142, electroencephalogram sensors 1148, blood pressure sensor 1144, or any exemplary biological sensor including, but not limited to, electrocardiogram (ECG) sensors, electromyogram (EMG) sensors, and glucose monitoring device. Data acquisition unit 114 may send the recorded patient data to patient device 104 through a wireless network in predefined secure approaches.

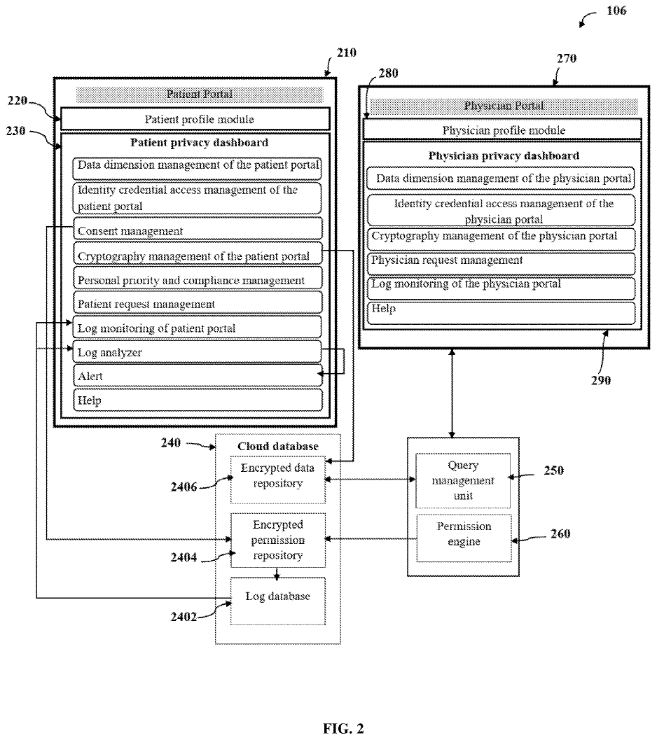

FIG. 2 illustrates a schematic representation of an exemplary privacy operation center system 106 for privacy monitoring of a cloud application with focus on healthcare industry requirements, consistent with one or more embodiments of the present disclosure. An exemplary POCs 106 may comprise a patient portal 210, a physician portal 270, a cloud database 240, a query management unit 250, and a permission engine 260. Permission engine 260 may search a plurality of permissions to confirm or deny patient consent about a request. Query management unit 250 may receive patient query and physician query.

Referring to FIG. 1 and FIG. 2, patient 102 and physician 108 may be authenticated by authentication server 120 to access POCs 106. Similar to the user side, on the service provider side, a physician device 118 may be required to use privacy regulatory system 100. In one or more exemplary embodiments, other individuals such as consultant physicians or medical students may also be able to access the patient data to observe or edit the patient data in specific occasions. In an exemplary embodiment, exemplary individuals that are allowed to access the patient data may be determined by patient 102 or physician 108. Patient portal 210 and physician portal 270 may be created in POCs 106 after patient registration and physician registration in privacy regulatory system 100.

In one exemplary embodiment, cloud database 240 may comprise a log database 2402, an encrypted permission repository 2404, and an encrypted data repository 2406. Log database 2402 may store a plurality of events. In one or more exemplary embodiments, each event of the plurality of events may comprise an exemplary incident that may occur in an exemplary privacy regulatory system 100. For instance, an exemplary event may include, but is not limited to, a data access request, patient data encryption, patient data decryption, and providing a service for a patient. In one or more exemplary embodiments, encrypted permission repository 2404 may store a plurality of permissions given by patient 102. Each respective permission of the plurality of permissions may determine whether a predetermined patient data is accessible to physician 108. For example, patient 102 may give permission to a physician, e.g., a cardiologist, to access a predetermined patient data, such as blood pressure, ECG signal, heart rate, glucose level, etc. In an exemplary embodiment, encrypted data repository 2406 may receive, send, and share a plurality of encrypted patient data. The plurality of encrypted patient data may be sent by patient device 104 or physician device 118 through the internet network of the patient device or the internet network of the physician device, respectively.

Referring again to FIG. 2, in an exemplary embodiment, patient 102 may use patient device 104 to access patient portal 210. Patient portal 210 may protect the patient clinical and non-clinical data. In one exemplary embodiment, patient portal 210 may comprise a patient profile module 220 and a patient privacy dashboard 230. Patient profile module 220 may include patient information and the patient data. In an exemplary embodiment, patient information may include non-clinical features like name, identification number, or any similar information. In one exemplary embodiment, the patient data may include clinical features like gender, age, weight, height, and medical historical documents.

Referring to FIG. 1 and FIG. 2, in an exemplary embodiment, patient privacy dashboard 230 may comprise a data dimension management of the patient portal component, an identity credential access management of the patient portal component, a consent management component, a cryptography management of the patient portal component, a personal priority and compliance management component, a patient request management component, a log monitoring of the patient portal component, a log analyzer component, an alert component, and a help component. The patient privacy dashboard 230 may provide a dynamic and flexible environment for each patient to determine personal priorities which may differ from one patient to another patient. Thereby, a personalized privacy may be guaranteed by using privacy regulatory system 100.

In an exemplary embodiment, the data dimension management of the patient portal component may provide an environment for patient 102 to determine allowed data types, allowed application scope of data, allowed data acquisition units, data sensitivity scale, data retention time, and metadata creation. Furthermore, the patient data may be received from data acquisition unit 114 may be managed through the data dimension management of the patient portal component. In an exemplary embodiment, patient 102 may access and manage one or more embedded applications in patient device 104 through the data dimension management of the patient portal component. Furthermore, patient 102 may manage the embedded applications of at least one data acquisition unit through the data dimension management of the patient portal component.

In an exemplary embodiment, the patient data may be stored in cloud database 240 through a data storage procedure after being received and encrypted. In one or more exemplary embodiments, allowed data types may be selected from a group consisting of text, number, voice, image, video, or any combination thereof. Allowed application scope of data may be selected from a group of consisting clinical, demographics, financial, administrative, or any combination thereof. Data sensitivity scale may be selected from a group consisting of restricted access sensitivity, high sensitivity, moderate sensitivity, and low sensitivity.

In an exemplary embodiment, the identity credential access management of the patient portal component may provide an environment for patient 102 to determine one or more allowed individuals, a data accessibility type and an access time duration. In an exemplary embodiment, one or more allowed individuals may get access to observe or edit patient data for the access time duration. In one exemplary embodiment, the identity credential access management of the patient portal component may enable patient 102 to determine the data accessibility type. In an exemplary embodiment, the data accessibility type may be selected from a group consisting of public access, limited access, and hidden access. The public access may make all patient data to be visible for physician 108 or the one or more allowed individuals. The limited access may make a limited part of patient data to be visible for physician 108 or the one or more allowed individuals. The hidden access may make all patient data to be hidden for physician 108 or the one or more allowed individuals unless the data accessibility may be changed.

In an exemplary embodiment, the consent management component may provide an environment for patient 102 to determine a plurality of patient permission for physician 108 or an allowed individual to observe or edit patient data. The consent management component may support with medical ethics principle. In one exemplary embodiment, the patient consent may be public consent. Thereby, patient 102 may consent that all physicians or allowed individuals access the patient data without sending any request. In an exemplary embodiment, the patient consent may be hierarchical consent. Thereby, if patient 102 permits that a first physician may access the patient data, the consent may work for other physicians that may be introduced as allowed individuals by the first physician.

In an exemplary embodiment, the cryptography management of the patient portal component may encrypt or decrypt the patient data through a cloud cryptography method or a cloud decryption method, respectively. All cloud cryptography methods or cloud decryption methods may be used for encrypting or decryption of the patient data.

In an exemplary embodiment, the personal priority and compliance management component may configure to define structural compliances, scope compliances, and content compliances. Furthermore, the personal priority and compliance management component may provide an environment for patient 102 to determine a patient territory. In an exemplary embodiment, structural compliances may comprise standards, legislation, regulation, act, policy, and guidelines. Scope compliances may comprise general target, general security, and security of the third-party side. Content compliances may comprise personal rights, technical services, and data flow specifications. In one or more exemplary embodiments, the structural compliances, the scope compliances, and the content compliances may be set based on the patient territory. Because standards, rights, and conditions may differ in different countries, the personal priority and compliance management component may use the proper standards, rights, and conditions based on the patient territory. Therefore, a comprehensive compliance management may be considered in privacy regulatory system 100. In an exemplary embodiment, patient 102 may not prefer to disclose complete or partial part of the patient identity information. Therefore, the personal priority and compliance management component may provide an environment for patient 102 to set the patient priority to hide complete or partial part of the patient identity information. Furthermore, the personal priority and compliance management component may determine which part of the patient data may be encrypted based on the patient priorities.

In an exemplary embodiment, the patient request management component may determine whether a request to access the patient data may be provided by physician 108, an allowed individual, or patient 102.

In an exemplary embodiment, the log analyzer may analyze a plurality of events to determine whether each respective event of the plurality events is an unusual event. An unusual event may be determined according to differences between the log database and a policy database. In one exemplary embodiment, the policy database may store a plurality of the user polices, wherein each respective policy of the plurality of the user polices may be determined based on the data dimension management of the user portal component, the identity credential access management of the user portal component, the consent management component, and the personal priority and compliance management component. Any machine learning method may be used to analyze the plurality of events in an inference engine. The inference engine may interpret and evaluate the plurality of events in the knowledge base to conclude new information. In one or more exemplary embodiment, an unusual event may include, but is not limited, to an unexpected data change, an unexpected data access, an unexpected event time, an unexpected event type, an unknown identity information, and a cyber-attack and may generate alert as a trigger.

In an exemplary embodiment, the log monitoring of the patient portal component, the log analyzer component, and the alert component may interact together to monitor, analyze and alert a plurality of events to determine whether each respective event of the plurality events is an unusual event. If an unusual event is detected, alert generation component will be activated and an alert will be sent. patient 102 may be informed by an email, a message, an alarm, or any similar method. In an exemplary embodiment, other related persons, like physician 108, who may be determined by patient 102 may be informed about the unusual event. In one or more exemplary embodiments, patient 102 may be informed of individuals who may access, observe, use, or edit the patient data through the log monitoring of the patient portal component, and the log analyzer component. Furthermore, patient 102 may know reasons and purposes behind any action in privacy regulatory system 100.

In one exemplary embodiment, physician 108 may have a physician portal 270 to use and edit the patient data with the patient permission and the patient consent to advise a treatment for patient 102. In an exemplary embodiment, physician portal 270 may comprise a physician profile module 280 and a physician privacy dashboard 290. Physician profile module 280 may include physician information such as name, age, gender, identification number, medical expertise, medical certifications, or any similar information. Physician privacy dashboard 290 may comprise a data dimension management of the physician portal component, an identity credential access management of the physician portal component, a cryptography management of the physician portal component, a physician request management component, a log monitoring of the physician portal component, and a help component.

In an exemplary embodiment, data dimension management of the physician portal component may provide an environment for physician 108 to edit allowed data types, allowed application scope of data, allowed data acquisition units, data sensitivity scale, data retention time, metadata, and the user data. In one exemplary embodiment, the identity credential access management the physician portal component may provide an environment for physician 108 to edit the one or more allowed individuals, edit the data accessibility type, and change the access time duration.

In an exemplary embodiment, the cryptography management of the physician portal component may encrypt the patient data through a cloud cryptography method. The cryptography management of the physician portal component may decrypt the patient data through a cloud decryption method whenever physician 108 may have a request to use the patient data which may be stored in encrypted data repository 2406. Moreover, original patient data, edited patient data by physician 108, and advised treatments may be encrypted before sending to encrypted data repository 2406 through the cryptography management of the physician portal component. In one exemplary embodiment, the physician request management component may send the physician request to access the patient data, edit allowed individuals, or manage the patient data. Physician 108 may monitor the patient data through the log monitoring of the physician portal component.

In one exemplary embodiment, an exemplary regulatory system 100 may include one or more second users who may observe the patient data, while the one or more second users may not be permitted to edit the patient data. For instance, an insurance companies, a medical student, research center members, and managers may be considered as a second user in privacy regulatory system 100. The second user may need a second user device to connect to POCs 106 through an internet network of the second user device and use a second user portal 212. The second user may be authenticated by authentication server 120 to access POCs 106.

In an exemplary embodiment, second user portal 212 may comprise a second user profile module 222 and a second user privacy dashboard 232. Second user profile module 222 may include second user information such as name, age, gender, identification number, or any similar information. Second user privacy dashboard 232 may comprise an identity credential access management of the second user portal component, a cryptography management of the second user portal component, a second user request management component, and a help component. In one or more exemplary embodiments, the identity credential access management of the second user portal may determine the second user access time to observe a part of the patient data. A part of the patient data may be determined by the patient permission. In an exemplary embodiment, the second user request management component may provide an environment for the second user to send a request. The cryptography management of the second user portal component may encrypt or decrypt the patient data through a cloud cryptography method or a cloud decryption method, respectively. Furthermore, the cryptography management of the second user portal component may hide the patient identity information for the second user.

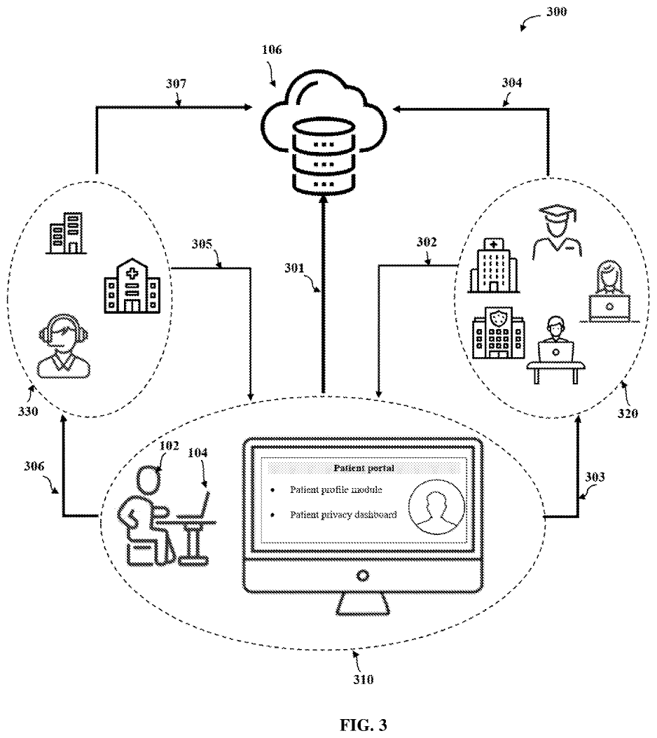

FIG. 3 illustrates schematic representation 300 of an exemplary relationship between different players in privacy regulatory system 100 for privacy monitoring of a cloud application to access the user data, consistent with one or more embodiments of the present disclosure. Referring to FIG. 1 and FIG. 3, in an exemplary embodiment, user side 310 may have direct connection 301 with POCs 106. In an exemplary embodiment, direct connection 301 may enable access the user data (owner data) stored in POCs 106. On the other hand, service provider side 320 may send access request 302 to user side 310. Service provider connection 304, that may enable access the user data stored in POCs 106, may work after verification message 303 from user side 310. Similar to service provider side 320, second user side 330 may send access request 305 to user side 310. In an exemplary embodiment, second user connection 307, that may enable access the user data stored in POCs 106, may work after receiving verification message 306 from user side 310.

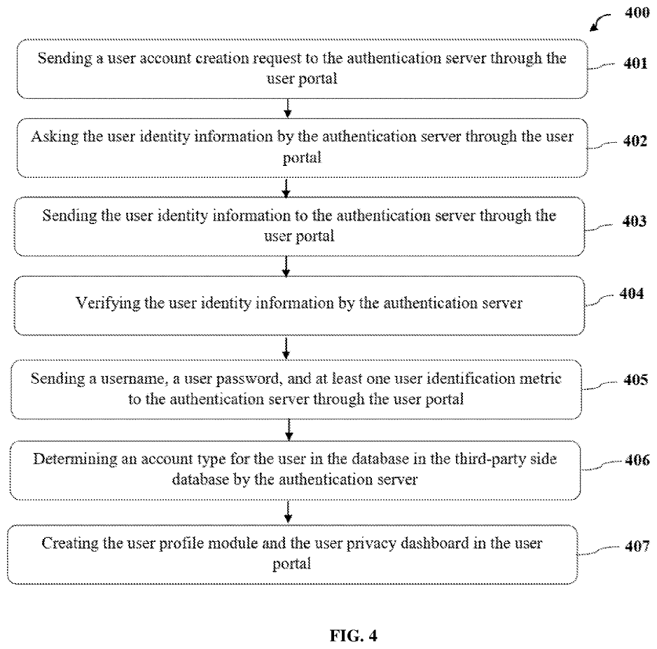

FIG. 4 illustrates a flowchart of user registration procedure 400 implemented in an exemplary privacy regulatory system, consistent with one or more embodiments of the present disclosure. In an exemplary embodiment, user registration procedure 400 may comprise sending a user account creation request to the authentication server through the user portal (step 401); asking the user identity information by the authentication server through the user portal (step 402); sending the user identity information to the authentication server through the user portal (step 403); verifying the user identity information by the authentication server (step 404); sending a username, a user password, and at least one user identification metric to the authentication server through the user portal (step 405); determining an account type for the user in the database in the third-party side by the authentication server (step 406); and creating the user profile module and the user privacy dashboard in the user portal (step 407).

Step 405 may include sending a username, a user password, and at least one user identification metric to authentication server through the user portal. In an exemplary embodiment, at least one user identification metric may be selected from a group of cryptography methods, a digital signature, a multi-authentication method, a face recognition identification method, a visual verification method, a fingerprint, a biometric parameter, or any combination thereof.

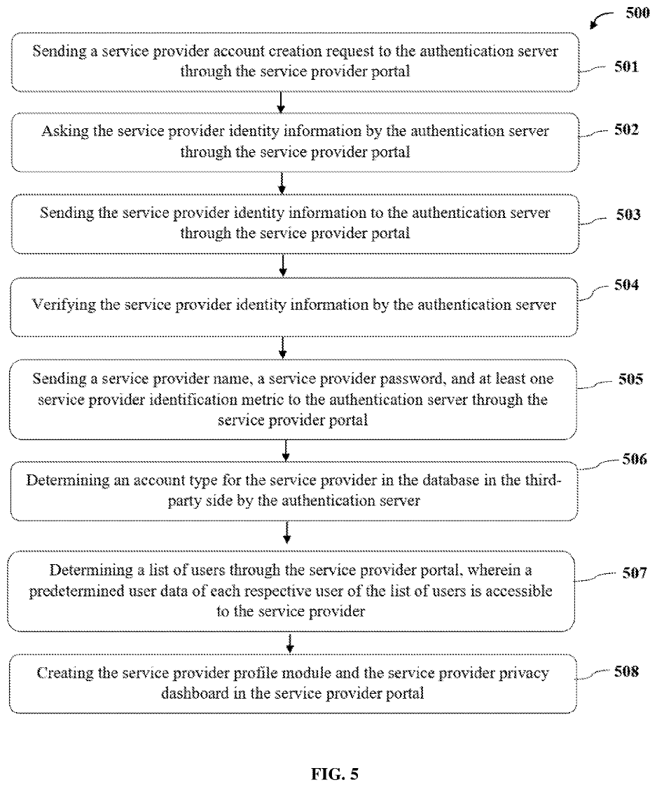

FIG. 5 illustrates a flowchart of service provider registration procedure 500 implemented in an exemplary privacy regulatory system, consistent with one or more embodiments of the present disclosure. In an exemplary embodiment, service provider registration procedure 500 may comprise sending a service provider account creation request to the authentication server through the service provider portal (step 501); asking the service provider identity information by the authentication server through the service provider portal (step 502); sending the service provider identity information to the authentication server through the service provider portal (step 503); verifying the service provider identity information by the authentication server (step 504); sending a service provider name, a service provider password, and at least one service provider identification metric to the authentication server through the service provider portal (step 505); determining an account type for the service provider in the database in the third-party side by the authentication server (step 506); determining a list of users through the service provider portal, wherein a predetermined user data of each respective user of the list of users is accessible to the service provider (step 507); and creating the service provider profile module and the service provider privacy dashboard in the service provider portal (step 508).

Step 505 may include sending a service provider name, a service provider password, and at least one service provider identification metric to the authentication server through the service provider portal. In an exemplary embodiment, at least one service provider identification metric may be selected from a group of cryptography methods, a digital signature, a multi-authentication method, a face recognition identification method, a visual verification method, a fingerprint, a biometric parameter, or any combination thereof.

Step 507 may include determining a list of users through the service provider portal, wherein a predetermined user data of each respective user of the list of users is accessible to the service provider. In an exemplary embodiment, the privacy regulatory system may use for healthcare application. A physician may access the patient data of the list of patients according to the consent management component, the personal priority and compliance component, the data dimension management of the patient portal component, and the identity credential access management of the patient portal component.

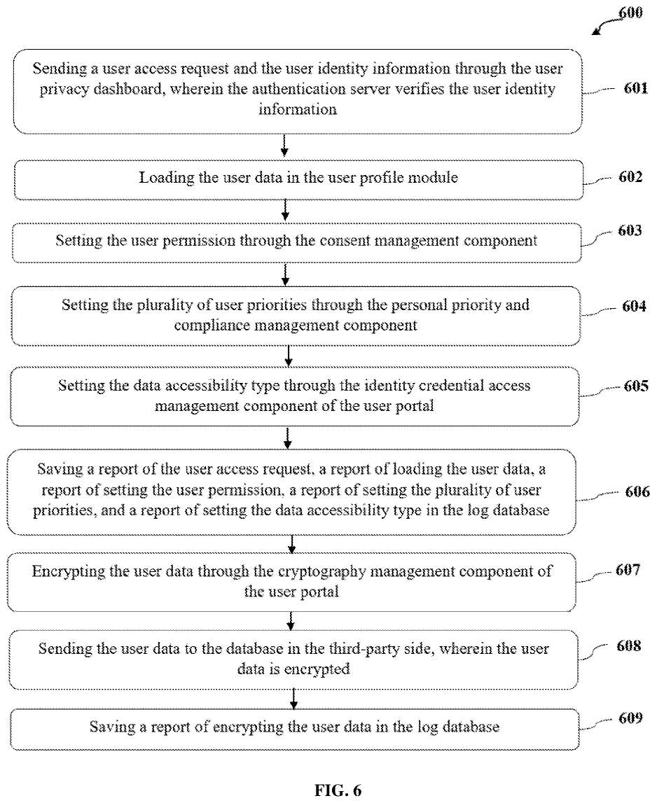

FIG. 6 illustrates a flowchart of data storage procedure 600 in an exemplary privacy regulatory system, consistent with one or more exemplary embodiments of the present disclosure. In an exemplary embodiment, data storage procedure 600 may comprise sending a user access request and the user identity information through the user privacy dashboard, wherein the authentication server verifies the user identity information (step 601); loading the user data in the data dimension management of the user portal component (step 602); setting the user permission through the consent management component (step 603); setting the plurality of user priorities through the personal priority and compliance management component (step 604); setting the data accessibility type through the identity credential access management of the user portal component (step 605); saving a report of the user access request, a report of loading the user data, a report of setting the user permission, a report of setting the plurality of user priorities, and a report of setting the data accessibility type in the log database (step 606); encrypting the user data through the cryptography management of the user portal component (step 607); sending the user data to the database in the third-party side, wherein the user data is encrypted (step 608); and saving a report of sending the user data to the database in the third-party side, in the log database (step 609).

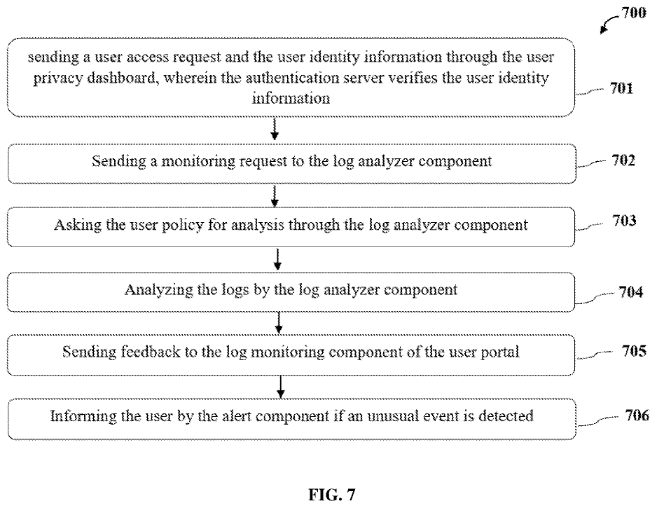

FIG. 7 illustrates a flowchart of log monitoring procedure 700 in an exemplary privacy regulatory system, consistent with one or more exemplary embodiments of the present disclosure. In an exemplary embodiment, log monitoring procedure 700 may comprise sending a user access request and the user identity information through the user privacy dashboard, wherein the authentication server verifies the user identity information (step 701); sending a monitoring request to the log analyzer component (step 702); asking the user policy for analysis through the log analyzer component (step 703); analyzing the logs by the log analyzer component (step 704); sending feedback to the log monitoring of the user portal component (step 705); and informing the user by the alert component if an unusual event is detected (step 706).

Step 703 may include analyzing the logs by the log analyzer component. For example, in an exemplary privacy regulatory system for a healthcare application, a patient may prefer a cardiologist to access the patient data for a determined month. If the cardiologist wants to access the patient data after the determined month, the log analyzer may detect an unusual event and send feedback to the patient. For instance, an email or a message may be sent to the patient.

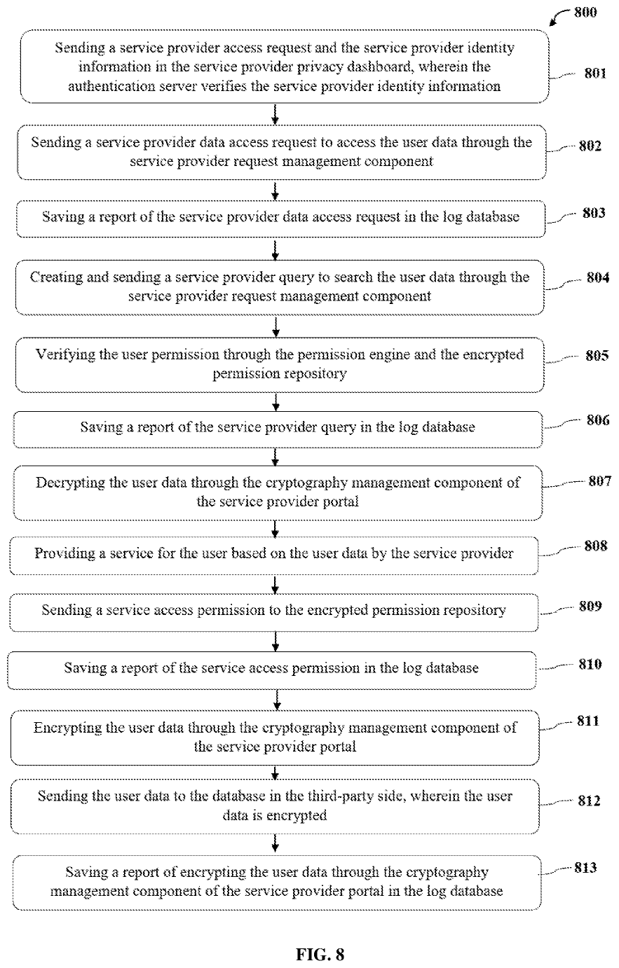

FIG. 8 illustrates a flowchart of service provider data management procedure 800 in an exemplary privacy regulatory system, consistent with one or more exemplary embodiments of the present disclosure. In an exemplary embodiment, service provider data management procedure 800 may comprise sending a service provider access request and the service provider identity information through the service provider privacy dashboard, wherein the authentication server verifies the service provider information (step 801); sending a service provider data access request to access the user data through the service provider request management component (step 802); saving a report of the service provider data access request in the log database (step 803); creating and sending a service provider query to search the user data through the service provider request management component (step 804); verifying the user permission through the permission engine and the encrypted permission repository (step 805); saving a report of the service provider query in the log database (step 806); decrypting the user data through the cryptography management of the service provider portal component (step 807); providing a service for the user by the service provider (step 808); sending a service access permission to the encrypted permission repository (step 809); saving a report of the service access permission in the log database (step 810); encrypting the user data through the cryptography management of the service provider portal component (step 811); sending the user data to the database in the third-party side, wherein the user data is encrypted (step 812); and saving a report of encrypting and sending the user data by the service provider privacy dashboard in the log database (step 813).

Step 808 may include providing a service for the user by the service provider. For example, in an exemplary privacy regulatory system for a healthcare application, step 808 may include advising treatment for a patient.

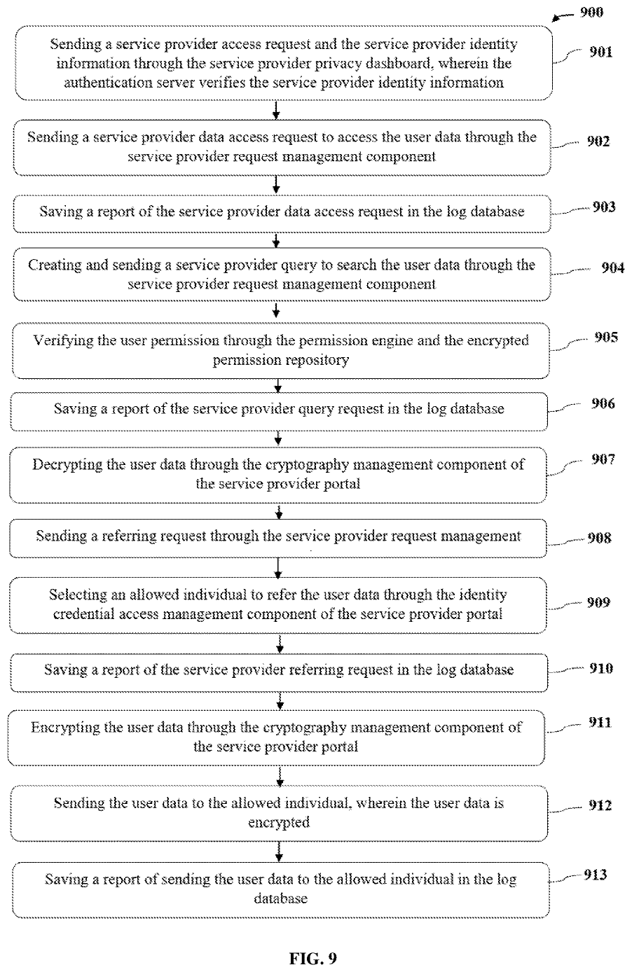

FIG. 9 illustrates a flowchart of data referring procedure 900 in an exemplary privacy regulatory system, consistent with one or more exemplary embodiments of the present disclosure. In one exemplary embodiment, data referring procedure 900 may comprise sending a service provider access request and the service provider identity information through the service provider privacy dashboard, wherein the authentication server verifies the service provider information (step 901); sending a service provider data access request to access the user data through the service provider request management component (step 902); saving a report of the service provider data access request in the log database (step 903); creating and sending a service provider query to search the user data through the service provider request management component (step 904); verifying the user permission through the permission engine and the encrypted permission repository (step 905); saving a report of the service provider query request in the log database (step 906); decrypting the user data through the cryptography management of the service provider portal component (step 907); sending a referring request through the service provider request management component (step 908); selecting an allowed individual to refer the user data through the identity credential access management of the service provider portal component (step 909); saving a report of the service provider referring request in the log database (step 910); encrypting the user data through the cryptography management of the service provider portal component (step 911); sending the user data to the allowed individual, wherein the user data is encrypted (step 912); and saving a report of the sending the user data to the allowed individual in the log database (step 913).

Step 909 may include selecting an allowed individual to refer the user data through the identity credential access management of the service provider portal component. In an exemplary privacy regulatory system for a healthcare application, a physician may need to refer the patient data to the consultant physician to decide about medical treatment through data referring procedure 900. Therefore, the consultant physician may be selected from the allowed individuals in the exemplary privacy regulatory system.

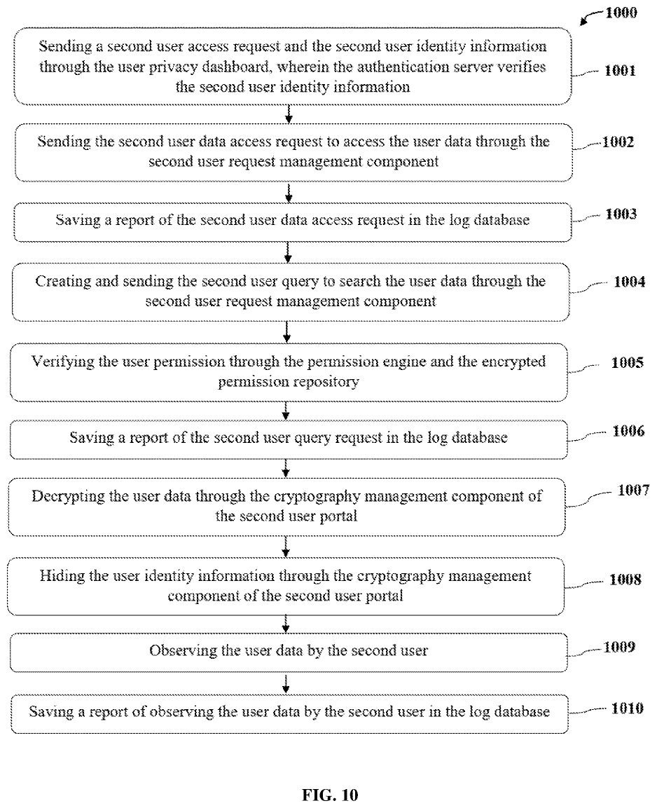

FIG. 10 illustrates a flowchart of second user data observation procedure 1000 in an exemplary privacy regulatory system, consistent with one or more exemplary embodiments of the present disclosure. In an exemplary embodiment, second user data observation procedure 1000 may comprise sending a second user portal access request and the second user identity information through the second user privacy dashboard, wherein the authentication server verifies the second user information (step 1001); sending the second user data access request to access the user data through the second user request management component (step 1002); saving a report of the second user data access request in the log database (step 1003); creating and sending the second user query to search the user data through the second user request management component (step 1004); verifying the user permission through the permission engine and the encrypted permission repository (step 1005); saving a report of the second user query request in the log database (step 1006); decrypting the user data through the cryptography management of the second user portal component (step 1007); hiding the user identity information through the cryptography management of the second user portal component (step 1008); observing the user data by the second user (step 1009); and saving a report of observing the user data by the second user in the log database (step 1010).

Step 1008 may include hiding the user identity information through the cryptography management of the second user portal component. For example, in an exemplary privacy regulatory system for a healthcare application, a medical student may want to observe the patient data for educational purposes. In such a situation, the patient identity may hide from the medical student to protect patient privacy.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. An element proceeded by “a” or “an” does not, without further constraints, preclude the existence of additional identical elements in the process, method, article, or apparatus that comprises the element.

Unless otherwise stated, all measurements, values, ratings, positions, magnitudes, sizes, and other specifications that are set forth in this specification, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study, except where specific meanings have otherwise been set forth herein. Relational terms such as “first” and “second” and the like may be used solely to distinguish one entity or action from another without necessarily requiring or implying any actual such relationship or order between such entities or actions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A privacy regulatory system, comprising:
a user device configured to receive user data from a user, wherein the user device is connected to the privacy regulatory system through an internet network of the user device, wherein the user device receives the user data from the user manually, automatically, or combination thereof, wherein the user device receives the user data automatically through at least one data acquisition unit comprising at least one sensor;
a service provider device connected to the privacy regulatory system through an internet network of the service provider device;
an authentication server configured to verify a user identity information and a service provider identity information; and
a privacy operation center system comprising:
a user portal comprising:
a user profile module comprising user information and the user data; and
a user privacy dashboard configured to protect the user data, wherein the user profile module and the user privacy dashboard are created in the user portal when the user registers in the privacy regulatory system through a user registration procedure;
a service provider portal configured to provide an environment for a service provider to access the user data, wherein the service provider portal comprises:
a service provider profile module comprising service provider information; and
a service provider privacy dashboard configured to protect the service provider information and the user data, wherein the service provider profile module and the service provider privacy dashboard are created in the service provider portal when the service provider registers in the privacy regulatory system through a service provider registration procedure;
a database in a third-party side comprising:
a log database configured to store a plurality of events;
an encrypted permission repository configured to store a plurality of permissions given by the user, wherein each respective permission of the plurality of permissions determines whether a predetermined user data is accessible to a service provider;
an encrypted data repository configured to:
receive a plurality of encrypted user data, wherein the plurality of encrypted user data is sent by the user device through the internet network of the user device, wherein the plurality of encrypted user data is sent by the service provider device through the internet network of service provider device;
send the plurality of encrypted user data; and
share the plurality of encrypted user data;
a permission engine configured to search a plurality of permissions; and
a query management unit configured to receive user query and service provider query.

2. The privacy regulatory system of claim 1, wherein the user privacy dashboard comprises:
a data dimension management of the user portal component configured to:
provide an environment for the user to determine allowed data types, allowed application scope of data, allowed data acquisition units, data sensitivity scale, data retention time, and metadata creation;
manage the user data received from at least one data acquisition unit;
manage the embedded applications of at least one data acquisition unit; and
access and manage one or more applications in the user device;
an identity credential access management of the user portal component configured to provide an environment for the user to determine one or more allowed individuals, a data accessibility type, and an access time duration, wherein the one or more allowed individuals get access to observe or edit the user data for the access time duration;
a consent management component configured to provide an environment for the user to determine a plurality user permission for a service provider or an allowed individual to observe or edit the user data;
a cryptography management of the user portal component configured to:
encrypt the user data through a cryptography method; wherein the user data is stored in the database in the third-party side through a data storage procedure after receiving and encrypting; and
decrypt the user data through a decryption method;
a personal priority and compliance management component configured to:
define structural compliances comprise standards, legislation regulation, act, policy, and guidelines;
define scope compliances comprise general target, general security, and security of the third-party side;
define content compliances comprise personal rights, technical services, and data flow specifications; and
provide an environment for the user to determine a user territory, wherein the structural compliances, the scope compliances, and the content compliances are set based on the user territory;
a user request management component configured to determine whether a request to access the user data is provided by a service provider, an allowed individual, or the user;
a log monitoring of the user portal component configured to provide an environment for the user to monitor a plurality of events through a log monitoring procedure;
a log analyzer component configured to analyze a plurality of events to determine whether each respective event of the plurality events is an unusual event, wherein an unusual event is determined according to differences between the log database and a policy database, wherein the policy database configured to store a plurality of the user polices, wherein each respective policy of the plurality of the user polices is determined based on the data dimension management of the user portal component, the identity credential access management of the user portal component, the consent management component, and the personal priority and compliance management component; and
an alert component configured to inform the user about the unusual event.

3. The privacy regulatory system of claim 2, wherein the identity credential access management the user portal component is configured to enable the user to determine the data accessibility type, wherein the data accessibility type is selected from a group consisting of public access, limited access, and hidden access, wherein the public access configured to make all the user data to be visible for the service provider or the one or more allowed individuals, wherein the limited access configured to make a limited part of the user data to be visible for the service provider or the one or more allowed individuals, wherein the hidden access configured to make all the user data to be hidden for the service provider or the one or more allowed individuals unless the data accessibility is changed.

4. The privacy regulatory system of claim 2, wherein the log analyzer component configured to analyze a plurality of events through a machine learning method in an inference engine.

5. The privacy regulatory system of claim 2, wherein the data storage procedure comprises:
sending a user access request and the user identity information through the user privacy dashboard, wherein the authentication server verifies the user identity information;
loading the user data in the data dimension management of the user portal component;
setting the user permission through the consent management component;
setting the plurality of user priorities through the personal priority and compliance management component;
setting the data accessibility type through the identity credential access management of the user portal component;
saving a report of the user access request, a report of loading the user data, a report of setting the user permission, a report of setting the plurality of user priorities, and a report of setting the data accessibility type in the log database;
encrypting the user data through the cryptography management of the user portal component;
sending the user data to the database in the third-party side, wherein the user data is encrypted; and
saving a report of sending the user data to the database in the third-party side, in the log database.

6. The privacy regulatory system of claim 2, wherein the log monitoring procedure comprises:
sending a user access request and the user identity information through the user privacy dashboard, wherein the authentication server verifies the user identity information;
sending a monitoring request to the log analyzer component;
asking the user policy for analysis through the log analyzer component;
analyzing the logs by the log analyzer component;
sending feedback to the log monitoring of the user portal component; and
informing the user by the alert component if an unusual event is detected.

7. The privacy regulatory system of claim 1, wherein the user registration procedure comprises:
sending a user account creation request to the authentication server through the user portal;
asking the user identity information by the authentication server through the user portal;
sending the user identity information to the authentication server through the user portal;
verifying the user identity information by the authentication server;
sending a username, a user password, and at least one user identification metric to the authentication server through the user portal;
determining an account type for the user in the database in the third-party side by the authentication server; and
creating the user profile module and the user privacy dashboard in the user portal.

8. The privacy regulatory system of claim 7, wherein at least one user identification metric is selected from a group of a cryptography method, a digital signature, a multi-authentication method, a face recognition identification method, a visual verification method, a fingerprint, a biometric parameter, or any combination thereof.

9. The privacy regulatory system of claim 1, wherein the service provider dashboard comprises:
a data dimension management of the service provider portal component configured to provide an environment for the service provider to edit allowed data types, allowed application scope of data, allowed data acquisition units, data sensitivity scale, data retention time, metadata, and the user data, wherein the service provider edits the user data through a service provider data management procedure;
an identity credential access management of the service provider portal component configured to provide an environment for the service provider to:
edit the one or more allowed individuals, wherein a predetermined user data is referred to the one or more allowed individual by the service provider through a data referring procedure;
edit the data accessibility type; and
change the access time duration;
a cryptography management of the service provider portal component configured to:
encrypt the user data through a cryptography method; and
decrypt the user data through a decryption method;
a service provider request management component configured to provide an environment for the service provider to send a request; and
a log monitoring of the service provider portal component configured to provide an environment for the service provider to monitor the log of data.

10. The privacy regulatory system of claim 9, wherein the service provider data management procedure comprises:
sending a service provider access request and the service provider identity information through the service provider privacy dashboard, wherein the authentication server verifies the service provider information;
sending a service provider data access request to access the user data through the service provider request management component;
saving a report of the service provider data access request in the log database;
creating and sending a service provider query to search the user data through the service provider request management component;
verifying the user permission through the permission engine and the encrypted permission repository;
saving a report of the service provider query in the log database;
decrypting the user data through the cryptography management of the service provider portal component;
providing a service for the user by the service provider;
sending a service access permission to the encrypted permission repository;
saving a report of the service access permission in the log database;
encrypting the user data through the cryptography management of the service provider portal component;
sending the user data to the database in the third-party side, wherein the user data is encrypted; and
saving a report of encrypting and sending the user data by the service provider privacy dashboard in the log database.

11. The privacy regulatory system of claim 9, wherein the data referring procedure comprises:
sending a service provider access request and the service provider identity information through the service provider privacy dashboard, wherein the authentication server verifies the service provider information;
sending a service provider data access request to access the user data through the service provider request management component;
saving a report of the service provider data access request in the log database;
creating and sending a service provider query to search the user data through the service provider request management component;
verifying the user permission through the permission engine and the encrypted permission repository;
saving a report of the service provider query request in the log database;
decrypting the user data through the cryptography management of the service provider portal component;
sending a referring request through the service provider request management component;
selecting an allowed individual to refer the user data through the identity credential access management of the service provider portal component;
saving a report of the service provider referring request in the log database;
encrypting the user data through the cryptography management of the service provider portal component;
sending the user data to the allowed individual, wherein the user data is encrypted; and
saving a report of sending the user data to the allowed individual in the log database.

12. The privacy regulatory system of claim 1, wherein the service provider registration procedure comprises:
sending a service provider account creation request to the authentication server through the service provider portal;
asking the service provider identity information by the authentication server through the service provider portal;
sending the service provider identity information to the authentication server through the service provider portal;
verifying the service provider identity information by the authentication server;
sending a service provider name, a service provider password, and at least one service provider identification metric to the authentication server through the service provider portal;
determining an account type for the service provider in the database in the third-party side by the authentication server;
determining a list of users through the service provider portal, wherein a predetermined user data of each respective user of the list of users is accessible to the service provider; and
creating the service provider profile module and the service provider privacy dashboard in the service provider portal.

13. The privacy regulatory system of claim 12, wherein at least one service provider identification metric is selected from a group consisting of a cryptography method, a digital signature, a multi-authentication method, a face recognition identification method, a visual verification method, a fingerprint, and a biometric parameter.

14. The privacy regulatory system of claim 1, further comprising:
at least one second user device connected to the privacy regulatory system through an internet network of at least one second user; and
at least one second user portal in the privacy operation center system comprising:
a second user profile module comprising a second user information; and
a second user privacy dashboard comprising:
an identity credential access management of the second user portal component configured to determine a second user access time to observe a part of the user data through a second user data observation procedure;
a second user request management component configured to provide an environment for a second user to send a request; and
a cryptography management of the second user portal component configured to:
encrypt the user data through a cryptography method;
decrypt the user data through a decryption method; and
hide the user identity information for the second user;
wherein the authentication server is configured to verify at least one second user identity information, wherein the encrypted permission repository configured to store a plurality of permissions given by the user, wherein each respective permission of the plurality of permissions determines whether a predetermined user data is accessible to the at least one second user.

15. The privacy regulatory system of claim 14, wherein the second user data observation procedure comprises:
sending a second user portal access request and the second user identity information through the second user privacy dashboard, wherein the authentication server verifies the second user information;
sending the second user data access request to access the user data through the second user request management component;
saving a report of the second user data access request in the log database;
creating and sending the second user query to search the user data through the second user request management component;
verifying the user permission through the permission engine and the encrypted permission repository;
saving a report of the second user query request in the log database;
decrypting the user data through the cryptography management of the second user portal component;
hiding the user identity information through the cryptography management of the second user portal component;
observing the user data by the second user; and
saving a report of observing the user data by the second user in the log database.
